(19) United States
(12) Patent Application Publication
(10) Pub. No.: US 2019/0033134 A1
(43) Pub. Date: Jan. 31, 2019

(54) SPECTROMETER

(71) Applicant: OXFORD UNIVERSITY INNOVATION LIMITED, Oxford (GB)

(72) Inventors: Elion Poem, Oxford (GB); Ian Walmsley, Oxford (GB)

(21) Appl. No.: 16/077,578

(22) PCT Filed: Feb. 10, 2017
(86) PCT No.: PCT/GB2017/050350

§ 371 Date: Aug. 13, 2018

(30) Foreign Application Priority Data
Feb. 11, 2016 (GB) 1602489.5

(51) Int. Cl. G01J 3/32; G01J 3/02; G01J 3/06; G01J 3/28

(52) U.S. Cl. CPC G01J 3/32; G01J 3/021; G01J 2003/1265; G01J 3/2823; G01J 3/06

(57) ABSTRACT

A spectrometer for temporally separating electromagnetic radiation (10) includes a cavity (105) having first and second reflecting mirrors (1, 2, 4, 5). The first mirror (1, 2) has an aperture (8) arranged to allow electromagnetic radiation (10) to be input into the cavity (105). The spectrometer also includes an imaging device (3) between the first and second mirrors (1, 2, 4, 5) that defines an optical axis of the cavity (105) and performs spatial Fourier transforms of the electromagnetic radiation (10). The first and/or second mirrors (1, 2, 4, 5) has a normal that is arranged at a non-parallel angle to the optical axis, such that the position and/or angle of incidence of electromagnetic radiation (10) on the second mirror is shifted after each round trip. The second mirror (4, 5) allows a wavelength component (14) of the electromagnetic radiation to be output from the cavity (105) when the position and/or angle of incidence of the electromagnetic radiation on the second mirror (4) after one or more round trips of the cavity (105) exceeds a threshold.

This invention relates to a spectrometer, in particular to a spectrometer arranged to perform spectral or spatial to temporal conversion of electromagnetic radiation.

Many applications require the spectrum of, e.g. a pulse of, electromagnetic radiation to be measured. There are an increasing number of applications that require accurate, efficient and fast characterisation of, e.g. multiple, faint and/or pulsed light sources, such as lidar systems, remote detection of chemical traces and the characterisation of quantum light sources.

Previous techniques include raster scanning, e.g. of the output from a monochromator or interferometer. However such a raster scanning technique is relatively slow (i.e. it takes a relatively long time to perform the spectroscopy measurement for an input pulse of electromagnetic radiation) and a lot of photons are missed (i.e. because the method is only able to detect a pair of frequencies at a time).

Improved techniques to overcome the raster scanning problem aim to convert the different frequencies of the input electromagnetic radiation into time differences, such that different frequencies are separated and detected by their time differences. One such implementation of this technique is to use a very long fibre optic cable that disperses the pulse into its different component frequencies owing to the different refractive indices the different wavelengths experience in the fibre optic cable.

However a number of problems are encountered with such implementations. For example, the fibre optic cable required has to be very long (of the order of ˜10 km) to induce enough dispersion, i.e. time separation of the different wavelengths, in the input pulse of electromagnetic radiation for a respectable resolution (e.g. to achieve 10 ns difference in delay for a wavelength difference of 10 nm).

An alternative solution using fibre optic cables is to provide multiple Bragg gratings at different positions in the fibre optic cable, that each reflect a particular frequency component of the incident electromagnetic radiation and transmit the remaining frequencies. This converts the different frequencies of the input electromagnetic radiation pulse into a series of time delayed pulses that are reflected and output from the fibre optic cable, i.e. from the different Bragg gratings, thus again converting the different wavelengths of the input electromagnetic radiation pulse into different time delayed pulses.

However, while using Bragg gratings allows a significantly shorter fibre optic cable to be used (compared to the above described system that relies on the dispersion of the fibre optic cable alone), only a constant, pre-defined set of particular wavelengths are able to be detected (i.e. those reflected from the different Bragg gratings and output from the fibre optic cable), thus providing a rather inflexible system. Furthermore, an optical circulator is required to separate the input electromagnetic radiation pulse from the output pulses (owing to the reflected pulses being output from the same end of the fibre optic cable as the pulse is input), which thus reduces the efficiency owing to transmission loss in the circulator.

The aim of the present invention is to provide an improved spectrometer, e.g. for such applications.

When viewed from a first aspect the invention provides a spectrometer for temporally separating input electromagnetic radiation, the spectrometer comprising:
a cavity comprising a first mirror and a second mirror arranged to reflect input electromagnetic radiation therebetween, wherein the first mirror comprises an aperture arranged to allow electromagnetic radiation to be input into the cavity through the aperture; and
an imaging device arranged in the path taken by the electromagnetic radiation between the first and second mirrors, wherein the imaging device defines an optical axis of the cavity and the imaging device is arranged to perform a spatial Fourier transform of the input electromagnetic radiation from the aperture in the first mirror onto the second mirror and to perform a spatial Fourier transform of the reflection of the electromagnetic radiation from the second mirror back onto the first mirror;
wherein at least a portion of one or both of the first and second mirrors has a normal that is arranged at a non-parallel angle to the optical axis of the cavity, such that the position and/or angle of incidence on the second mirror of electromagnetic radiation input into the cavity through the aperture in the first mirror is shifted after each round trip of the electromagnetic radiation through the cavity; and
wherein the second mirror is arranged to allow a wavelength component of the electromagnetic radiation to be output from the cavity when the position and/or angle of incidence of the electromagnetic radiation on the second mirror after one or more round trips of the cavity exceeds a particular threshold such that different wavelength components of the input electromagnetic radiation are output from the cavity after completing a different number of round trips of the cavity.

The present invention provides a spectrometer that can be used to separate electromagnetic radiation temporally (i.e. in time) that is input into the cavity of the spectrometer. The cavity of the spectrometer is defined by two end mirrors (the first and second mirrors) that are positioned, with an imaging device between them, such that the input electromagnetic radiation is reflected between the mirrors (e.g. multiple times) via the imaging device.

The mirrors are provided and arranged such that at least a portion of the first mirror and/or at least a portion of the second mirror has a normal that is at a non-parallel angle to the optical axis of the cavity (this being defined by the imaging device between the mirrors, with the optical axis preferably passing through the first and second mirrors). This angled portion of the first and/or second mirror causes the position and/or angle of incidence of the input electromagnetic radiation on the second mirror to be shifted after each round trip of the electromagnetic radiation through the cavity.

(It should be noted that the “round trip” of the electromagnetic radiation through the cavity is defined as the path the electromagnetic radiation follows to arrive back at substantially the same position on the (portion of the) mirror, other than the shift applied to the electromagnetic radiation. Thus, depending on the position of the aperture in the first mirror (e.g. relative to the optical axis), the angle at which the electromagnetic is input into the cavity and the relative arrangement of the (portion(s) of the) mirrors, the round trip of the electromagnetic radiation through the cavity may be involve passing via the imaging device four times (and thus involve two reflections off the first mirror and one off the second mirror) to return to substantially the same position on the second mirror, as will be explained in more detail below. Furthermore, as will also be described in more detail below, the electromagnetic radiation, e.g. within a pulse, may not all be input into the cavity through the aperture in the first mirror at the same angle and may therefore follow different paths through the cavity.)

The second mirror is arranged to allow a wavelength component, e.g. a particular wavelength or range of wavelengths, of the electromagnetic radiation that was input into the cavity to be output from the cavity after the electromagnetic radiation has taken one or more rounds trips through the cavity. The second mirror does this by allowing the wavelength component to be output when a particular incident position and/or angle of the electromagnetic radiation on the second mirror exceeds a particular, e.g. predetermined, threshold. Thus, as the angle and/or position of incidence of the electromagnetic radiation on the second mirror is shifted after each round trip of the electromagnetic radiation through the cavity (owing to the angle of the (portion(s) of the) mirrors relative to the optical axis), after a particular number of round trips a particular wavelength component will be output from the cavity. Owing to the arrangement of the second mirror, the cavity thus selectively allows different wavelength components of the electromagnetic radiation input into the cavity to be output from the cavity after completing a different number of round trips through the cavity, thus outputting the different wavelength components at different respective times from the cavity.

Thus it will be appreciated that the spectrometer of the present invention performs temporal separation of electromagnetic radiation input into the cavity using a free space configuration (i.e. not requiring the input electromagnetic radiation to be confined to an optical fibre). Using a free space spectrometer rather than one based on an optical fibre helps to allow a greater bandwidth spectrum of electromagnetic radiation to be analysed.

Providing a spectrometer that performs temporal separation of electromagnetic radiation enables a spectrum of electromagnetic radiation to be measured efficiently as the different wavelength components of the spectrum are separated into multiple different time bins. The temporal separation of the different wavelength components of the electromagnetic radiation means that it may not be necessary to use a detector that is able to measure a range of frequencies at different spatial positions, as would be output from, e.g., a grating spectrometer. Such a detector, e.g. a charge-coupled device (CCD) or a complementary metal-oxide-semiconductor (CMOS) detector, is relatively slow, e.g. having a repetition rate of kHz or possibly MHz.

Instead, a single channel detector may be able to be used. Such a detector can therefore be chosen for its speed rather than its wavelength resolution, enabling it to be much faster, e.g. having a repetition rate of the order of GHz or higher (e.g. for an avalanche photo diode (APD)) compared to a repetition rate of kHz or possibly MHz for a CCD or CMOS detector. This then enables electromagnetic radiation from correlated or dynamic systems to be measured more efficiently by the spectrometer according to embodiments of the present invention.

Furthermore, the spectrometer of the present invention may be tuned easily, e.g. to be selective to a particular range of wavelengths to be measured. Such tuning may be effected, for example, by the angle(s) of the mirror(s) that are chosen. This provides a more flexible spectrometer compared to the restrictive set of fixed wavelengths that are predetermined by an optical fibre containing Bragg gratings, for example.

The electromagnetic radiation to be input into the cavity and measured by the spectrometer may be derived from any suitable and desired source of electromagnetic radiation. While there are many such sources of electromagnetic radiation, the Applicant believes the spectrometer of the present invention to be particularly suitable for the measurement of electromagnetic radiation from lidar systems, chemical traces and quantum light sources. Generally the source of electromagnetic radiation will provide a spectrum (range) of wavelengths to be measured by the spectrometer.

The electromagnetic radiation to be input into the cavity and measured by the spectrometer may have any suitable and desired wavelength and thus the spectrometer (and in particular the cavity) is configured to measure the wavelength of any suitable and desired electromagnetic radiation that is input into the cavity. In a preferred embodiment the spectrometer is configured to measure the wavelength of electromagnetic radiation having a wavelength between 200 nm and 2 μm (i.e. from near ultraviolet, through the visible spectrum, to near infrared), preferably a wavelength between 400 nm and 700 nm (i.e. the visible spectrum). Thus preferably the first and second mirrors are capable of reflecting electromagnetic radiation having a wavelength between 200 nm and 2 μm), preferably a wavelength between 400 nm and 700 nm, and the imaging device is capable of imaging electromagnetic radiation having a wavelength between 200 nm and 2 μm), preferably a wavelength between 400 nm and 700 nm.

The electromagnetic radiation that is input into the cavity may be in any suitable and desired form, e.g. depending on the source of the electromagnetic radiation to be measured by the spectrometer. For example, the electromagnetic radiation may be a continuous stream of electromagnetic radiation. However, in a preferred example the electromagnetic radiation to be input into the cavity comprises a pulse of electromagnetic radiation. Analysing a pulse of electromagnetic radiation using the spectrometer of the present invention is convenient because the timing of the pulse that is input into the cavity may be correlated with the wavelength components of the electromagnetic radiation that are output from the cavity, thus aiding the determination of the wavelength of these wavelengths components.

In one embodiment the electromagnetic radiation that is input into the cavity may be formed as a collimated beam of electromagnetic radiation, arranged to be directed through the aperture of the cavity. Thus the spectrometer may comprise a device, e.g. a collimator (or other device that directs the electromagnetic radiation into the cavity without spectral diffraction), arranged to collect electromagnetic radiation (from a source of electromagnetic radiation to be measured by the spectrometer) and to direct the collimated beam of electromagnetic radiation through the aperture of the cavity.

In another embodiment the electromagnetic radiation that is input into the cavity may be formed as an angularly divergent beam of electromagnetic radiation, arranged to be directed through the aperture of the cavity. As will be seen, in some embodiments this initial angular separation of the input electromagnetic radiation helps to provide the desired temporal separation, e.g. owing to the different (e.g. wavelengths) components of the electromagnetic radiation that are input at different respective directions into the cavity taking different paths through the cavity and thus, for example, having different angles and/or positions of incidence on the second mirror. Thus preferably the spectrometer comprises an angular separation device arranged to angularly separate electromagnetic radiation that is incident upon it and to direct the angularly separated electromagnetic radiation through the aperture of the cavity.

Preferably the angular separation device is arranged to angularly separate the incident electromagnetic radiation dependent upon the wavelength components of the electromagnetic radiation. In a preferred embodiment the angular separation device comprises a diffraction grating or a prism.

Preferably the spectrometer comprises an input imaging device (e.g. a mirror or preferably one or more lenses) arranged to focus the angularly separated electromagnetic radiation from the angular separation device onto the aperture of the cavity. Preferably the input imaging device is arranged to focus the angularly separated electromagnetic radiation onto the aperture of the cavity such that the electromagnetic radiation angularly diverges in the cavity (but passes through the aperture substantially at a single point).

Preferably the angularly separated electromagnetic radiation that is input into the cavity is arranged to be angularly separated within a plane, e.g. in which the aperture of the cavity lies (in the embodiments in which the aperture is longitudinally extended, as will be described below). Thus preferably the angular separation device is arranged to angularly separate the electromagnetic radiation within a plane, e.g. in which the aperture of the cavity lies (in the embodiments in which the aperture is longitudinally extended, as will be described below).

In a preferred embodiment, e.g. when the electromagnetic radiation to be input into the cavity is collimated or is angularly separated within a plane, the electromagnetic radiation is arranged to be directed into the cavity at a non-parallel angle to the optical axis of the cavity. Preferably the non-parallel angle is the angle between the direction of collimation of the input electromagnetic radiation, or the plane in which the input electromagnetic radiation is angularly separated, and the optical axis of the cavity (in the embodiments in which the electromagnetic radiation to be input into the cavity is collimated or is angularly separated within a plane respectively).

In one embodiment the non-parallel angle to the optical axis at which the input electromagnetic radiation enters the cavity through the aperture is less than 10 degrees, e.g. between 2 and 8 degrees, e.g. between 3 and 7 degrees, e.g. 5 degrees. Inputting the electromagnetic radiation into the cavity at an angle to the optical axis may help to direct the electromagnetic radiation initially onto a portion of the second mirror at a position at which it cannot escape from the cavity, thus helping to allow for the selective output from the cavity (e.g. when directed towards a different portion of the second mirror) when the electromagnetic radiation has completed one or more round trips of the cavity, as will be discussed in more detail below. In the embodiment in which the electromagnetic radiation that is input into the cavity is angularly separated within a plane, preferably the plane is oriented at this non-parallel angle to the optical axis, such that all the input electromagnetic radiation (regardless of its angular separation within the plane) enters the cavity at the same angle with respect to the direction of the optical axis.

The first and second mirrors may comprise any suitable and desired type of mirrors. In one embodiment the first mirror and/or the second mirror (or at least the portions thereof) are planar. Preferably the (e.g. portions of the) first and second mirrors are each large enough to accommodate the electromagnetic radiation incident upon them, for a sufficient number of reflections to enable the cavity to be able to discriminate between the different wavelength components of the electromagnetic radiation. The dimensions of the (e.g. portions of the) first and second mirrors may depend on a number of factors, e.g. how the (e.g. portions of the) first and second mirrors are angled with respect to each other, the angle(s) at which the (e.g. portions of the) first and second mirrors are arranged with respect to each other, the spectral width of the input electromagnetic radiation, the physical width of the beam of the input electromagnetic radiation, the characteristics of the angular separation device, the characteristics of the imaging device.

When the angle at which one (e.g. portion of a) mirror is arranged with respect to the other (e.g. portions of the) mirror such that the angle of the former mirror causes the position of incidence of the electromagnetic radiation on the other (e.g. portions of the) mirror to be shifted after each round trip through the cavity, preferably the other (e.g. portions of the) mirror have a dimension in the direction of the shift that is greater than the total shift of the electromagnetic radiation. For example, preferably the (e.g. each portion of the) first mirror has a dimension of at least 0.5 cm (e.g. approximately 1 cm) in a direction perpendicular to the direction in which the aperture is longitudinally extended.

Furthermore, when the incident electromagnetic radiation is angularly separated, thus resulting in a spread of the different wavelength components on the (e.g. portion of the) second mirror, preferably the (e.g. portion of the) second mirror has a dimension of at least 5 mm (e.g. approximately 1 cm) in a direction parallel to the direction in which the aperture is longitudinally extended. Preferably the (e.g. each portion of the) second mirror has a dimension of at least 0.5 cm (e.g. approximately 1 cm) in a direction perpendicular to the direction in which the aperture is longitudinally extended.

When the input electromagnetic radiation is not angularly separated and/or the position of incidence of the electromagnetic radiation on the (e.g. portions of the) first and/or second mirrors is not shifted, then the respective (e.g. portions of the) first and/or second mirrors may be able to have a dimension that is simply large enough to accommodate the width of the incident beam of electromagnetic radiation. Typically this is less than 1 mm, e.g. approximately 0.1 mm.

The aperture in the first mirror may be provided in any suitable and desired way and may comprise any suitable and desired shape, such that it allows electromagnetic radiation to be input into the cavity for analysis. In one embodiment the first mirror comprises two separate portions defining the aperture therebetween, i.e. the two portions of the first mirror are separated from each other to allow the aperture to be provided. As will be explained below, this arrangement conveniently allows, in some embodiments, the two portions of the first mirror to be arranged at an angle to each other.

In one embodiment the aperture is longitudinally extended, e.g. a slit, preferably in a direction perpendicular to the optical axis of the cavity. Preferably the depth of the aperture (i.e. in a direction perpendicular to the direction in which the aperture is longitudinally extended) is minimised in order to maximise the usable area of the first mirror. Thus preferably the depth of the aperture is only just greater than the width of the beam of electromagnetic radiation at the point it passes through the aperture. For example, preferably the depth of the aperture is less than 1 mm, e.g. approximately 0.5 mm.

Preferably the input electromagnetic radiation is directed into the cavity through the aperture in a direction that is perpendicular to the direction in which the aperture is longitudinally extended, e.g. at a non-parallel angle to the optical axis. In the embodiment in which the electromagnetic radiation that is input into the cavity is angularly separated within a plane, preferably the plane is oriented such that the direction of longitudinal extension of the aperture lies in this plane, e.g. at a non-parallel angle to the optical axis.

Preferably an (e.g. at least one) edge of (e.g. at least one portion of) the first mirror that defines the aperture comprises a razor edge. Providing a razor edge to the first mirror allows the electromagnetic radiation to be input into the cavity as close as possible to the first mirror, thus minimising the width of the aperture in the first mirror and maximising the available area of the first mirror, which thus minimises the size of the first mirror that is able to be provided in the cavity. For example, preferably the electromagnetic radiation is arranged to be input from the razor edge at a distance of half the width of the beam of electromagnetic radiation when it passes through the aperture, e.g. at a distance of less than 0.5 mm, e.g. at a distance of approximately 0.25 mm.

The aperture may be provided as a static gap between two portions of the first mirror, e.g. as described in the arrangement above. However in one embodiment the first mirror comprises a shutter arranged to open to form the aperture. Providing a shutter may help to prevent electromagnetic radiation that has been input into the cavity from escaping, and thus preferably the shutter comprises a mirror (e.g. to form part of (a portion of) the first mirror) on its face that is within the cavity (i.e. same side as the first mirror and, e.g., coplanar with (at least a portion of) the first mirror).

In one embodiment the aperture is offset by a distance from the optical axis of the cavity, e.g. in a direction perpendicular to the optical axis. This offset helps to avoid the electromagnetic radiation from being incident upon the aperture (and thus escaping from the cavity) after it has been reflected by the second mirror. When the aperture is longitudinally extended, preferably the offset of the aperture from the optical axis is in a direction perpendicular to the direction in which the aperture is longitudinally extended. When the first mirror comprises two portions, preferably the gap between the two portions defining the aperture is offset by a distance from the optical axis of the cavity.

Preferably the (e.g. the (e.g. razor) edge of the first mirror forming the) edge of the aperture further from the optical axis is offset from the optical axis by between 1 mm and 4 mm, e.g. by between 2 mm and 3 mm. Thus in the embodiment in which the aperture is defined by a gap between two portions of the first mirror, preferably one of the portions has an, e.g. razor, edge forming the edge of the aperture and is further from the optical axis than the edge of the other portion that forms the other edge of the aperture. Thus also in this embodiment, the optical axis preferably passes through the portion of the first mirror having the edge that is closer to the optical axis (e.g. the edge that is not the razor edge).

In the embodiment in which the electromagnetic radiation passes through the aperture (that is offset from the optical axis) in the first mirror at an angle to the optical axis of the cavity, preferably the electromagnetic radiation is arranged to be directed at an angle towards the optical axis. Thus, when the electromagnetic radiation that is input into the cavity is angularly separated within a plane, preferably the plane is oriented (i.e. at a non-parallel angle to the optical axis) such that the plane intersects the optical axis within the cavity.

The imaging device may comprise any suitable and desired imaging device to spatially Fourier transform the electromagnetic radiation from one mirror to the other. In one embodiment the imaging device comprises a mirror. In this embodiment the optical axis thus comprises two halves that are both on the same side (i.e. the reflective side) of the mirror (i.e. the same side as the first and second mirrors) and thus the two halves of the optical axis (between the first mirror and the mirror, and between the second mirror and the mirror respectively) are not parallel or collinear, but will generally lie in the same plane.

The mirror may comprise any suitable and desired mirror. In one embodiment the mirror comprises a spherical mirror. However, a spherical mirror may introduce astigmatism, e.g. for electromagnetic radiation reflected by the mirror away from its optical axis. Therefore preferably the mirror comprises a mirror having different radii of curvature on its two axes (e.g. a toroidal, ellipsoidal or parabolic (with unequal curvatures) mirror), as this shape of mirror helps to minimise the astigmatism, e.g. compared to a spherical mirror. Preferably the different radii of curvature on the two axes of the mirror are chosen depending on the angle of incidence of the electromagnetic radiation into the cavity.

In a preferred embodiment the imaging device comprises a lens. The lens may comprise any suitable and desired type of lens. The lens may comprise a compound lens but preferably the imaging lens comprises (e.g. is solely) a double convex lens. The lens is preferably arranged such that the optical axis is collinear either side of the lens.

For the embodiments of the invention that are discussed, above and below, it is to be understood that the geometry of the cavity will be described with respect to an optical axis that takes a single direction through the cavity, i.e. is collinear either side of the imaging device (unless otherwise stated explicitly). Thus, in the embodiments in which the optical axis is not collinear either side of the imaging device, e.g. when the cavity comprises a mirror, when the geometry in these embodiments is described it is assumed that the necessary transformation is made to the two halves of the optical axis (either side of the imaging device) such that the optical axis is collinear, e.g. as if the optical axis were folded out from its actual configuration.

The cavity may be any suitable and desired dimensions and thus the first and second mirrors may be spaced from the imaging device by any suitable and desired distance. In a preferred embodiment one or both (and preferably each) of the first and second mirrors are spaced from the imaging device along the optical axis of the cavity by a distance that corresponds to the focal length of the imaging device, e.g. the focal length of the imaging mirror or lens.

The imaging device, e.g. mirror or lens, may have any suitable and desired focal length. In one embodiment the focal length of the imaging device is between 20 mm and 100 mm, e.g. between 40 mm and 80 mm, e.g. 60 mm.

The first and second mirrors (or portions thereof) may be arranged in any suitable and desired way in order to introduce a shift in the position and/or angle of incidence on the second mirror of the electromagnetic radiation after each round trip of the electromagnetic radiation through the cavity. There are a number of different configurations in which this may be achieved, e.g. depending on whether a positional and/or angular shift is to be introduced to the electromagnetic radiation input into the cavity. For example, the whole of one or both of the first and the second mirrors may be arranged such that the normals to these mirrors are at a non-parallel angle to the optical axis of the cavity. Alternatively, only a portion of one or both of the first and second mirrors may be arranged such that the normals to these mirror portions are at a non-parallel angle to the optical axis of the cavity, e.g. the first and/or second mirror may also include a portion that has a normal that is arranged parallel to the optical axis of the cavity.

In one set of embodiments the first mirror, preferably a portion of the first mirror, has a normal that is arranged at a non-parallel angle to the optical axis of the cavity. Preferably the non-parallel angle of the normal to the (e.g. portion of the) first mirror is arranged such that the position of incidence on the second mirror of electromagnetic radiation input into the cavity through the aperture in the first mirror is shifted after each round trip of the electromagnetic radiation through the cavity (an angular shift to the electromagnetic radiation reflected from the (e.g. portion of the) first mirror will generally be transformed into a positional shift on the second mirror owing to the Fourier-transformative effect of the imaging device through which the electromagnetic radiation passes from the first mirror to the second mirror). Preferably the positional shift on the second mirror for each round trip is between 0.1 mm and 2 mm, e.g. between 0.2 mm and 1 mm.

Preferably the non-parallel angle of the normal to the (e.g. portion of the) first mirror is arranged such that the direction of the positional shift (which preferably remains in the same direction, and thus increases, for each round trip of the electromagnetic radiation through the cavity) is parallel to, for example, the direction in which the aperture is longitudinally extended, and/or the plane in which the input electromagnetic radiation is angularly separated (in the embodiments that possess these preferable features). Thus preferably the axis about which the (e.g. portion of the) first mirror is rotated to provide the non-parallel angle of its normal to the optical axis extends in a direction perpendicular to the direction of the positional shift.

When the first mirror comprises two portions defining the aperture therebetween, preferably one portion of the first mirror has a normal that is parallel to the optical axis of the cavity and the other portion has a normal that is arranged at a non-parallel angle to the optical axis of the cavity. In this embodiment, preferably the portion of the first mirror that has its normal that is parallel to the optical axis of the cavity has an edge (e.g. the (e.g. razor) edge of the first mirror) forming the edge of the aperture that is offset and further from the optical axis than the edge of the other portion of the first mirror (that forms the other edge of the aperture), e.g. such that the optical axis passes through the portion of the first mirror having the normal that is arranged at a non-parallel angle to the optical axis of the cavity.

Preferably the two portions of the first mirror either side of the aperture are rotated with respect to each other by the angle (by which the normal of the portion of the first mirror is arranged to the optical axis) about an axis that extends in a direction perpendicularly to the aperture in the first mirror and perpendicularly to the optical axis of the cavity (and thus, for example, there is no common line, e.g. at the location of the aperture, along which the planes of the two portions of the first mirror intersect).

When the whole of the first mirror is arranged with its normal at a non-parallel angle to the optical axis of the cavity, preferably the mirror is rotated from a position perpendicular to the optical axis through the angle (by which the normal of the first mirror is arranged to the optical axis) about an axis that extends in a direction perpendicularly to the aperture in the first mirror and perpendicularly to the optical axis of the cavity (though it should be noted that at this angle, the aperture in the first mirror extends in a direction that is no longer perpendicular to the optical axis).

In one set of embodiments the second mirror, preferably a portion of the second mirror, has a normal that is arranged at a non-parallel angle to the optical axis of the cavity. Preferably the non-parallel angle of the normal to the (e.g. portion of the) second mirror is arranged such that the angle of incidence on the second mirror of electromagnetic radiation input into the cavity through the aperture in the first mirror is shifted after each round trip of the electromagnetic radiation through the cavity (an angular shift to the electromagnetic radiation reflected from the (e.g. portion of the) second mirror will generally be transformed into an angular shift on the second mirror after a round trip through the cavity owing to the electromagnetic radiation having been spatially Fourier transformed by the imaging device an even number of times after this round trip through the cavity). Preferably the angular shift on the second mirror for each round trip is between 1 milliradian and 50 milliradians, e.g. between 2 milliradians and 20 milliradians.

Preferably the non-parallel angle of the normal to the (e.g. portion of the) second mirror is arranged such that the axis of rotation of the angular shift (which preferably remains in the same direction, and thus increases, for each round trip of the electromagnetic radiation through the cavity) is parallel to, for example, the direction in which the aperture is longitudinally extended, and/or the axis about which the (e.g. portion of the) second mirror is rotated, e.g. in a direction perpendicular to the optical axis of the cavity (in the embodiments that possess these preferable features).

In one embodiment the second mirror comprises two portions, e.g. arranged either side of the optical axis. When the second mirror comprises two portions, preferably one portion of the second mirror has normal that is parallel to the optical axis of the cavity and the other portion has a normal that is arranged at a non-parallel angle to the optical axis of the cavity. In this embodiment, preferably the portion of the second mirror that has its normal that is non-parallel to the optical axis of the cavity is arranged on the same side of the optical axis as the portion of the first mirror that has its normal that is parallel to the optical axis of the cavity, and thus also preferably the portion of the second mirror that has its normal that is parallel to the optical axis of the cavity is arranged on the same side of the optical axis as the portion of the first mirror that has its normal that is non-parallel to the optical axis of the cavity (when the first mirror also comprises two portions arranged at an angle to each other).

Preferably the two portions of the second mirror are rotated with respect to each other by the angle (by which the normal of the portion of the first mirror is arranged to the optical axis) about an axis, e.g. along which the planes of the two portions of the second mirror intersect, that extends in a direction perpendicularly to the optical axis of the cavity and, e.g., parallel to the aperture in the first mirror (or the projection of the aperture onto a plane that is perpendicular to the optical axis, when the whole of the first mirror is rotated such that the aperture is no longer perpendicular to the optical axis). Preferably the direction along which the planes of the two portions of the second mirror intersect forms the boundary between the two portions of the second mirror, e.g. there is no gap between the two portions of the second mirror (a gap between the two portions of the second mirror is not necessary as there is no aperture to be defined in the second mirror as for the first mirror). The boundary between the two portions of the second mirror may be offset from the optical axis but preferably the boundary between the two portions of the second mirror lies on the optical axis, i.e. the two portions of the second mirror are arranged such that the optical axis intersects the boundary between the two portions.

When the whole of the second mirror is arranged with its normal at a non-parallel angle to the optical axis of the cavity, preferably the mirror is rotated from a position perpendicular to the optical axis through the angle (by which the normal of the second mirror is arranged to the optical axis) about an axis that extends in a direction perpendicularly to the optical axis of the cavity and, e.g., parallel to the aperture in the first mirror (assuming that the whole of the first mirror has not been rotated such that the aperture is no longer perpendicular to the optical axis).

As discussed above, one or both of the (e.g. portions of the) first and second mirrors may be arranged to have their normals at non-parallel angles to the optical axis. In one embodiment only the (e.g. portion of the) first mirror is arranged with its normal at a non-parallel angle to the optical axis (and thus also the second mirror is arranged perpendicular (with its normal parallel) to the optical axis). In another embodiment only the (e.g. portion of the) second mirror is arranged with its normal at a non-parallel angle to the optical axis (and thus also the first mirror is arranged perpendicular (with its normal parallel) to the optical axis). However, in a preferred embodiment both the (e.g. portions of the) first and second mirrors are arranged to have their normals at non-parallel angles to the optical axis. Thus the first and second mirrors (or, e.g., portions thereof) may shift both the angle and position of incidence of the electromagnetic radiation on the second mirror.

In this latter embodiment, preferably the (e.g. portion of the) first mirror is arranged at an angle to introduce an angular shift when the electromagnetic radiation is incident upon the second mirror and the (e.g. portion of the) second mirror is arranged at an angle to introduce a positional shift when the electromagnetic radiation is incident again upon the second mirror. Preferably the axis about which the (e.g. portions of the) first mirror is rotated extends in a direction that is perpendicular to the direction in which the axis about which the (e.g. portions of the) second mirror is rotated extends.

It should be noted that the angles at which the (e.g. portions of the) first and/or second mirrors are arranged may be any suitable and desired angles. For example, the (e.g. portion of the) first mirror may be arranged with its normal at a first angle to the optical axis and/or the (e.g. portion of the) second mirror may be arranged with its normal at a second angle to the optical axis. The first and second angles may be independent of each other or they may be related to each other in some way, e.g. they may be the same or similar to each other but this is not necessary.

In one embodiment the first angle and/or the second angle is less than 5 degrees, e.g. less than 4 degrees, e.g. less than 3 degrees, e.g. 2 degrees. As indicated above, the values of the first and second angles may be chosen independently from each other.

It should also be noted that although (e.g. a portion of) one or more of the first and second mirrors is arranged with its normal at an angle to the optical axis, other than this angle or angles, preferably the first and second mirrors are arranged to lie in respective planes that are perpendicular to the optical axis. Furthermore, e.g. as discussed above, the angle at which the (e.g. a portion of the) first and/or second mirror is oriented is relatively small (e.g. maximum 5 degrees) and, when provided, the angle at which the electromagnetic radiation enters the cavity is relatively small (e.g. maximum 10 degrees), such that preferably the spectrometer (and in particular the cavity) is arranged to allow the input electromagnetic radiation to take a plurality of round trips through the cavity. In other words, preferably the angular or positional shift applied to the electromagnetic radiation for each round trip is significantly smaller than the size of the (e.g. portions of the) first and/or second mirrors.

In a preferred embodiment, the cavity is arranged (in particular the (e.g. portions of the) first and second mirrors, and the imaging device) such that the “round trip” of the electromagnetic radiation through the cavity involves passing via the imaging device four times (and thus involves two reflections off the first mirror and one off the second mirror) to return to substantially the same position on the second mirror. To achieve this, preferably the electromagnetic radiation is arranged to enter the cavity through the aperture in the first mirror offset to and/or at an angle to the optical axis of the cavity. Thus, in this embodiment, the electromagnetic radiation enters through the aperture; it is spatially Fourier transformed by the imaging device onto one half (e.g. portion) of the second mirror on the opposite side of the optical axis from the, e.g. offset, aperture; it is reflected by this half of the second mirror and spatially Fourier transformed by the imaging device onto one half (e.g. portion) of the first mirror on the other side of the optical axis from the, e.g. offset, aperture (i.e. the same side of the optical axis as the half of the second mirror the electromagnetic radiation has just been reflected off); it is reflected by this half of the first mirror and spatially Fourier transformed by the imaging device onto the other half (e.g. portion) of the second mirror on the same side of the optical axis as the, e.g. offset, aperture (i.e. the opposite side of the optical axis as the half of the first mirror the electromagnetic radiation has just been reflected off); and the electromagnetic radiation is then reflected by this half of the second mirror and spatially Fourier transformed by the imaging device onto the half (e.g. portion) of the first mirror on the same side of the optical axis as the, e.g. offset, aperture (i.e. the same side of the optical axis as the half of the second mirror the electromagnetic radiation has just been reflected off) to start a further round trip through the cavity.

The second mirror may be arranged to allow the various wavelength components of the input electromagnetic radiation to be output from the cavity when the position and/or the angle of incidence of the electromagnetic radiation on the second mirror exceeds a particular threshold in any suitable and desired way.

In a first set of embodiments the second mirror is arranged to allow a wavelength component of the electromagnetic radiation to be output from the cavity when the position of incidence of the electromagnetic radiation on the second mirror after one or more round trips of the cavity exceeds a particular position threshold. Thus in these embodiments the first and/or second (preferably the first) mirrors are arranged such that the position of incidence of the electromagnetic radiation on the second mirror is shifted after each round trip of the electromagnetic radiation through the cavity such that, for a particular wavelength component of the electromagnetic radiation, when this component has completed a particular number of round trips through the cavity and thus its position has been shifted by a particular cumulative amount (distance), it exceeds the threshold position of incidence on the second mirror and thus is output from the cavity.

In these embodiments the second mirror may be configured in any suitable and desired way such that wavelength components of the electromagnetic radiation are output from the cavity when the particular position threshold is exceeded. In one embodiment the second mirror comprises a razor edge that defines the position threshold. Thus, once a wavelength component has its position of incidence on the second mirror shifted past the position threshold, i.e. past the razor edge, the wavelength component will not be reflected by the second mirror but instead will be output from the cavity.

For example, when the input electromagnetic radiation is angularly separated dependent on its wavelength components, e.g. in a plane that is perpendicular to the direction of the axis about which the (e.g. portion of the) first mirror is rotated to provide the non-parallel angle of its normal to the optical axis, the imaging device will spatially Fourier transformed the different wavelength components onto different positions on the second mirror (separated in a direction parallel to the plane in which the input electromagnetic radiation is angularly separated). Thus, when the position of incidence of the electromagnetic radiation on the second mirror is shifted after each round trip through the cavity (owing to the reflection from the (e.g. portion of the), e.g. first, mirror having its normal at a non-parallel angle to the optical axis), a wavelength component of the electromagnetic radiation will be shifted beyond the razor edge of the second mirror after a particular number of round trips and thus be output from the cavity. After, e.g. each, subsequent round trip further wavelength components of the electromagnetic radiation may then be output from the cavity when their position of incidence on the second mirror has been shifted by a great enough distance (owing to the reflections from the (e.g. portion of the), e.g. first, mirror having its normal at a non-parallel angle to the optical axis) to exceed the position of the razor edge of the second mirror. This process therefore separates the different wavelength components of the input electromagnetic radiation into different time delayed components, which may then be detected to determine the time delays and thus convert these into wavelength measurements (as will be detailed further below).

In another embodiment the second mirror comprises a gradient spectral filter comprising a plurality of spectral edges (e.g. a spectral notch, a spectral edge, a spectral line, a spectral band-pass filter) that is arranged to transmit a plurality of (different) wavelength components of the electromagnetic radiation when the wavelength components exceed respective (different) position thresholds (i.e. the respective plurality of spectral edges) on the second mirror. The gradient spectral filter operates in a similar manner to the razor edge described above, except that the positions of the spectral edges of the gradient spectral filter (at which the second mirror is arranged to transmit a particular wavelength component) depend on the wavelength of the electromagnetic radiation that is incident upon the second mirror at that particular position. Thus the threshold position depends on the wavelength of the electromagnetic radiation that is incident upon the second mirror such that different wavelengths of the electromagnetic radiation need to exceed different positions of incidence on the second mirror to be transmitted through the second mirror and output from the cavity. For example, position of the spectral edge may change by about 10% of the central wavelength over about 5 cm, e.g. approximately 0.2% per mm. Thus, for a typical wavelength range the transmission wavelengths of the spectral edges may change from approximately 780 nm to 860 nm over a distance of about 5 cm.

In this embodiment, the shifting position of incidence of the electromagnetic radiation on the second mirror, e.g. owing to the reflection from the (e.g. portion of the) first mirror having its normal at a non-parallel angle to the optical axis, resulting in the output of different wavelength components at different times from the cavity, operates in a similar manner to that described above for the embodiment in which the second mirror comprises a razor edge. However, in this embodiment it is not necessary (though it is possible) for the input electromagnetic radiation to be angularly separated first; the electromagnetic radiation may be input through the aperture as a collimated beam. When the electromagnetic radiation is input through the aperture as a collimated beam, all of the wavelength components of the input electromagnetic radiation follow the same path through the cavity and the discrimination between the different wavelength components is made by the gradient spectral filter such that different wavelength components are emitted when the beam of electromagnetic radiation reaches different respective positions of incidence on the second mirror, such that the different wavelength components are temporally separated (owing to the different wavelength components having completed a different number of round trips through the cavity to reach these different positions).

It will thus be appreciated that the dispersion of the different wavelength components of the input electromagnetic radiation to be measured by the spectrometer may be provided by an angular separation device or a gradient spectral filter. The type of angular separation device or gradient spectral filter used may determine the spectral (i.e. wavelength) resolution that is achievable by the spectrometer. Generally, it has been found that an angular separation device (e.g. a diffraction grating) provides a finer spectral resolution than a gradient spectral filter.

The razor edge of the second mirror, either for the simple razor edge or for the spectral edges in the gradient spectral filter, may be positioned and oriented in any suitable and desired direction. Preferably the razor or spectral edge forms a straight line that extends in a direction that is perpendicular to the direction in which the electromagnetic radiation is shifted after each round trip through the cavity. Preferably the direction in which the razor or spectral edge extends is perpendicular to the optical axis of the cavity (at least on the side of the cavity that the second mirror is located). Preferably the direction in which the razor or spectral edge extends is perpendicular to, or lies in the same plane as, the direction in which the aperture is longitudinally extended (in the embodiment in which the aperture is longitudinally extended in a direction perpendicular to the optical axis of the cavity). Preferably, also, the direction in which the razor or spectral edge extends is parallel to the direction of the axis about which the (e.g. portion of the) first mirror is rotated to provide the non-parallel angle of its normal to the optical axis. Preferably the razor or spectral edge is positioned on the side of the (e.g. portion of the) second mirror towards which the normal to the angled (e.g. portion of the) first mirror is oriented.

In a second set of embodiments the second mirror is arranged to allow a wavelength component of the electromagnetic radiation to be output from the cavity when the angle of incidence of the electromagnetic radiation on the second mirror after one or more round trips exceeds a particular angular threshold. Thus in these embodiments the first and/or second (preferably the second) mirrors are arranged such that the angle of incidence of the electromagnetic radiation on (e.g. a portion of) the second mirror is shifted after each round trip of the electromagnetic radiation through the cavity such that, for a particular wavelength component of the electromagnetic radiation, when this component has completed a particular number of round trips through the cavity and thus its angle of incidence has been shifted by a particular cumulative amount (angle), it exceeds the threshold angle of incidence on the second mirror and thus is output from the cavity.

In these embodiments the second mirror may be configured in any suitable and desired way such that the wavelength components of the electromagnetic radiation are output from the cavity when the particular angular threshold is exceeded. Preferably the second mirror comprises an angle-dependent spectral filter arranged to transmit a plurality of (different) wavelength components of the electromagnetic radiation when the wavelength components exceed respective (different) angular thresholds on the second mirror. Thus the angle at which the second mirror is arranged to transmit a particular wavelength component (and thus the threshold angle of the second mirror) depends on the wavelength of the electromagnetic radiation that is incident upon the second mirror such that different wavelengths of the electromagnetic radiation need to exceed different angles of incidence on the second mirror to be transmitted through the second mirror and output from the cavity. For example, the dependence of the angles at which respective wavelength components are transmitted is quadratic about 0 degrees. For small angles, the average ratio may be about 0.1% of the central wavelength per degree, e.g. 15 nm for 20 degrees around 800 nm.

For example, when the angle of incidence of the electromagnetic radiation on the second mirror is shifted after each round trip through the cavity (owing to the reflection from the (e.g. portion of the), e.g. second, mirror having its normal at a non-parallel angle to the optical axis), a wavelength component of the electromagnetic radiation will be shifted beyond the threshold angle of incidence on the angle-dependent spectral filter of the second mirror for that wavelength component after a particular number of round trips and thus be output from the cavity. After each subsequent round trip further wavelength components of the electromagnetic radiation may then be output from the cavity when their angle of incidence on the second mirror has been shifted by a great enough angle (owing to the further reflections from the (e.g. portion of the), e.g. second, mirror having its normal at a non-parallel angle to the optical axis) to exceed the (different) threshold angle of incidence on the second mirror for that (different) wavelength component. This process therefore separates the different wavelength components of the input electromagnetic radiation into different time delayed components, which may then be detected to determine the time delays and thus convert these into wavelength measurements (as will be detailed further below).

When an angle-dependent spectral filter is used, because the output of the wavelength components of the electromagnetic radiation depends upon the angles of incidence of the respective components on the second mirror, which is preferably shifted by the (e.g. portion of the) second mirror being arranged with its normal at a non-parallel angle to the optical axis, it is not necessary (but it may be possible) for the input electromagnetic radiation to be angularly separated first. Therefore in a preferred embodiment the electromagnetic radiation is arranged to be input through the aperture into the cavity as a collimated beam of electromagnetic radiation.

It should also be noted that in some embodiments a gradient spectral filter may also be angle dependent, i.e. for the wavelengths that it transmits, as well as being position dependent. Thus the angle-dependent spectral filter may comprise a gradient spectral filter. This has the advantage that the gradient spectral filter can be used to tune the wavelength range that the gradient spectral filter is suitable for using with, simply by shifting the gradient spectral filter laterally.

In a third set of embodiments the second mirror is arranged to allow a wavelength component of the electromagnetic radiation to be output from the cavity when the angle of incidence of the electromagnetic radiation on the second mirror after one or more round trips exceeds a particular angular threshold and the position of incidence of the electromagnetic radiation on the second mirror after one or more (e.g. the same number of) round trips exceeds a particular position threshold. Thus in these embodiments the first and/or second (preferably the first and second) mirrors are arranged such that the angle and position of incidence of the electromagnetic radiation on the second mirror is shifted after each round trip of the electromagnetic radiation through the cavity such that, for a particular wavelength component of the electromagnetic radiation, when this component has completed a particular number of round trips through the cavity and thus its angle of incidence has been shifted by a particular cumulative amount (angle) and its position of incidence has been shifted by a particular cumulative amount (distance), it exceeds the threshold angle of incidence and the threshold position of incidence on the second mirror and thus is output from the cavity.

In these embodiments the second mirror may be configured in any suitable and desired way such that the wavelength components of the electromagnetic radiation are output from the cavity when the particular angular and position thresholds are exceeded. Preferably the second mirror comprises a gradient dielectric filter arranged to transmit a plurality of (different) wavelength components of the electromagnetic radiation when the wavelength components exceed respective (different) angular and position thresholds on the second mirror. Thus the angle and position at which the gradient dielectric filter of the second mirror is arranged to transmit a particular wavelength component (and thus the threshold angle and position of the second mirror) depends on the wavelength of the electromagnetic radiation that is incident upon the second mirror such that different wavelengths of the electromagnetic radiation need to exceed different angles and positions of incidence on the second mirror to be transmitted through the second mirror and output from the cavity. The dependence of the gradient dielectric filter on position and angle of transmission with wavelength will be similar to that described above for the gradient spectral filter and the angle-dependent spectral filter.

The spectrometer, in particular the cavity, may be arranged to temporally separate the input electromagnetic radiation into any suitable and desired number of different wavelength components. As will be appreciated, this may depend on the total wavelength range of the input electromagnetic radiation, although the spectrometer may be tuned to efficiently measure an expected input spectrum, e.g. by choosing appropriate angle(s) at which the (e.g. portion of the) first and/or second mirrors are to be arranged, depending on the source of the electromagnetic radiation. For example, the angle(s) at which the (e.g. portion of the) first and/or second mirrors are to be arranged may be chosen such that the shift in angle or position of incidence of the electromagnetic radiation on the second mirror that is introduced after each round trip of the electromagnetic radiation through the cavity divides the total wavelength range of the input electromagnetic radiation into a suitable and desired number of different wavelength components (bins).

In one embodiment the spectrometer, e.g. the cavity (e.g. the dimensions of the cavity, the dimensions and/or reflectivity of the (e.g. portions of the) first and/or second mirrors, and/or the angle(s) of the (e.g. portion of the) first and/or second mirrors), is arranged to temporally separate the input electromagnetic wavelength into at least 10 different wavelength components, e.g. greater than 15 wavelength components, e.g. approximately 20 wavelength components.

The efficiency of the cavity, e.g. owing to the reflectivity of the mirrors, may limit the number of round trips possible within the cavity and thus may limit the number of wavelength components into which the cavity may be able to temporally separate the input electromagnetic wavelength. In a preferred embodiment the (e.g. portions of the) first and second mirrors have a reflectivity greater than 99.9%, e.g. greater than 99.95%, e.g. greater than 99.99%.

The total wavelength range of the wavelength components that are output from the cavity may be any suitable and desired wavelength range, e.g. depending on the number of wavelength components. In a preferred embodiment the spectrometer is arranged such that the total wavelength range of the wavelength components that are output from the cavity is greater than 10 nm, e.g. greater than 15 nm, e.g. greater than 20 nm, e.g. greater than 50 nm. In some embodiments the total wavelength range may even be up to or greater than 100 nm.

Related to this, the spectrometer (and in particular the cavity) may be arranged to provide any suitable and desired wavelength resolution for the measurement of the input electromagnetic radiation, e.g. given by the wavelength separation of the wavelength components. In one embodiment the spectrometer, e.g. the cavity (e.g. the dimensions of the cavity, the dimensions of the (e.g. portions of the) first and/or second mirrors, the angle(s) of the (e.g. portion of the) first and/or second mirrors, and/or the spectral filter) or the angular separation device, is arranged to provide a wavelength resolution of less than 5 nm, e.g. less than 2 nm, e.g. less than 1 nm, e.g. less than 0.1 nm, e.g. 0.01 nm.

In embodiments in which the wavelength components of the input electromagnetic radiation are discrete, preferably the cavity (e.g. the dimensions of the cavity, the dimensions of the (e.g. portions of the) first and/or second mirrors, and/or the angle(s) of the (e.g. portion of the) first and/or second mirrors) is arranged to allow a single discrete wavelength component to be output from the cavity after, e.g. each or a plurality of, round trip(s) of the electromagnetic radiation through the cavity.

Once the temporally separated wavelength components of the electromagnetic radiation have been output from the cavity, they may be used or processed in any suitable and desired way, e.g. in order to determine the time delays between the wavelength components. In a preferred embodiment the spectrometer comprises a detector arranged relative to the cavity such that the wavelength components output from the cavity are incident upon the detector.

The detector may comprise any suitable and desired detector for measuring the arrival of the wavelength components, e.g. a photodetector. In a preferred embodiment the detector comprises a single channel detector (the spectrometer may be arranged such that it is possible to measure the spectrum of the input electromagnetic radiation simply by determining the time at which each wavelength component is output from the cavity, e.g. it may not be necessary to measure the particular wavelength of each wavelength component directly but instead just the presence of the wavelength component). In a preferred embodiment the detector comprises an avalanche photo diode. An avalanche photo diode possesses a relatively high single photon efficiency and a relatively high temporal resolution (fast response).

The repetition rate (or time resolution) of the detector (at which the detector is able to resolve separate wavelength components) may be any suitable and desired rate. In a preferred embodiment the repetition rate is greater than 1 MHz, e.g. greater than 10 MHz, e.g. greater than 100 MHz, e.g. greater than 1 GHz, e.g. 2 GHz.

In one embodiment the spectrometer comprises an imaging device, e.g. positioned between the output from the cavity and the detector, and arranged to image the wavelength components output from the cavity onto the detector. This may help to focus all the output wavelength components onto a single detector. The imaging device may comprise one or more lenses or a mirror, for example.

Preferably the cavity (e.g. the dimensions of the cavity, the dimensions of the (e.g. portions of the) first and/or second mirrors, and/or the angle(s) of the (e.g. portion of the) first and/or second mirrors) is arranged to allow the wavelength components of the input electromagnetic radiation to be output at a rate that is less than the repetition rate of the detector.

The measurements made by the detector may be used in any suitable and desired way, e.g. to determine the wavelength of the wavelength components output from the cavity and detected by the detector. In a preferred embodiment the detector is connected to a processing system (e.g. a data processor, e.g. a computer) arranged to receive signals from the detector, e.g. related to the measurement of the respective wavelength components made by the detector, and to determine from the signals the time delays between the arrival of the wavelength components at the detector, e.g. relative to the input of the electromagnetic radiation into the cavity. The processing system preferably is arranged to determine, from the signals received from the detector, the intensity of the respective wavelength components.

Preferably the processing system is also arranged to use the determined time delays to determine the wavelengths of the wavelength components output from the cavity (and detected by the detector). Preferably the processing system uses a calibration of the spectrometer, e.g. of the cavity, to determine the wavelength of the wavelength components output from the cavity from the determined time delays. Preferably the processing system uses a calibration of the spectrometer, e.g. of the cavity, to determine the intensity of the wavelength components output from the cavity from the determined intensities of the respective wavelength components.

In one embodiment the spectrometer is arranged to temporally separate electromagnetic radiation from two sources of electromagnetic radiation contemporaneously. Preferably this is achieved by the spectrometer analysing two different polarisation modes simultaneously. This allows the spectrometer to analyse two channels of electromagnetic radiation which is convenient, for example, for the measurement of the joint spectrum of a two mode emitter, e.g. a two mode squeezer.

Thus in a preferred embodiment the spectrometer comprises a polarisation device arranged to convert electromagnetic radiation from two sources of electromagnetic radiation into two different polarisations and to be input together into the cavity through the aperture. Preferably the spectrometer also comprises a polarising beam-splitter arranged to receive the wavelength components output from the cavity and to separate the two different polarisations. Preferably the spectrometer also comprises two detectors arranged to receive the wavelength components for the two respective different polarisations from the polarising beam-splitter. The two different polarisations of the wavelength components may then be analysed, e.g. using the determined time delays of the respective wavelength components, to produce a joint spectrum.

The spectrometer may comprise a plurality of cavities, e.g. to enable high order joint spectra to be measured.

Although the spectrometer has been described primarily for measuring the wavelength components of input electromagnetic radiation, the Applicant envisages that the spectrometer may be used for a number of other different purposes. For example, the spectrometer may be used as an imaging device. In this embodiment the image to be analysed is focussed onto the aperture of the cavity, e.g. using a lens, which converts the different positions in the image into different angles for the electromagnetic radiation that is input into the cavity, i.e. it angularly separates the input electromagnetic radiation. The cavity, as described above, then converts the different angles (corresponding to the different positions in the image) into different time delays. To analyse a two dimensional image, each row of the image would then be scanned to produce the full image.

In another example the spectrometer, e.g. with a long cavity, may be used to generate a train of pulses of electromagnetic radiation that are emitted from the cavity at different angles and different times. These pulses may then be passed through a lens to illuminate different rows on an object. Then, the transmitted, reflected, or emitted light could be directed into a short cavity, such that light from each position within a row enters the cavity at a different angle. The cavity will then delay each, e.g. reflected, pulse by a different amount of time, thus outputting a “train of trains” of pulses. This is actually the entire object spread in time, one row after the other, which enables imaging with a single pixel camera to be performed without any moving parts.

In yet another example the spectrometer may be used as a pulse train generator. In this embodiment the electromagnetic radiation to be input into the cavity is first spatially shaped, e.g. using a mask or a spatial light modulator, before it is focussed into the cavity through the aperture. The shape of the input electromagnetic radiation therefore determines the intensity of light in each angularly separated component. The cavity then separates the different angular components into different time delays such that the desired pulse train (e.g. with different intensities in the different time separated pulses based on the different intensities of the angularly separated components) is output from the cavity.

Embodiments of the invention will now be described, by way of example only, with reference to the accompanying drawings, in which:

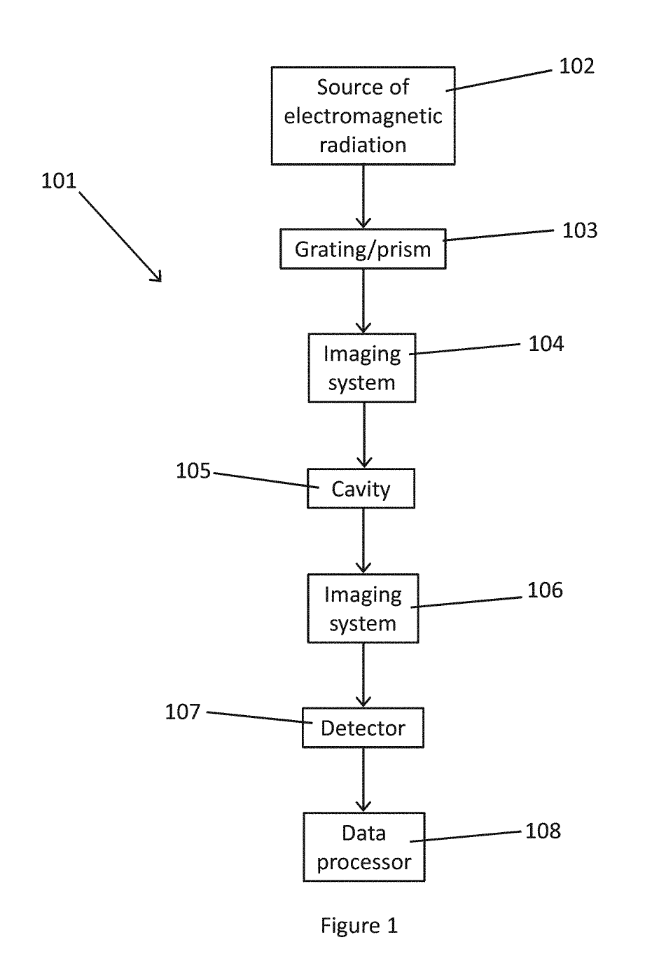

FIG. 1 shows a schematic overview of a spectrometer according to an embodiment of the present invention;

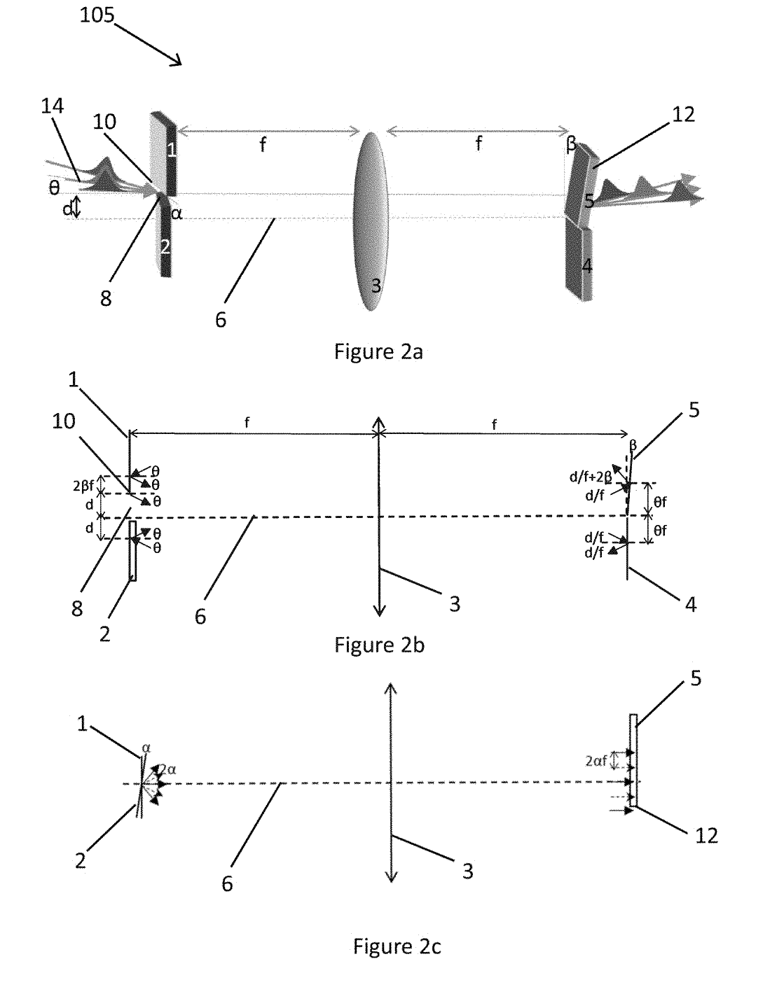

FIGS. 2a, 2b and 2c show the details of a cavity to be used in the spectrometer shown in FIG. 1;

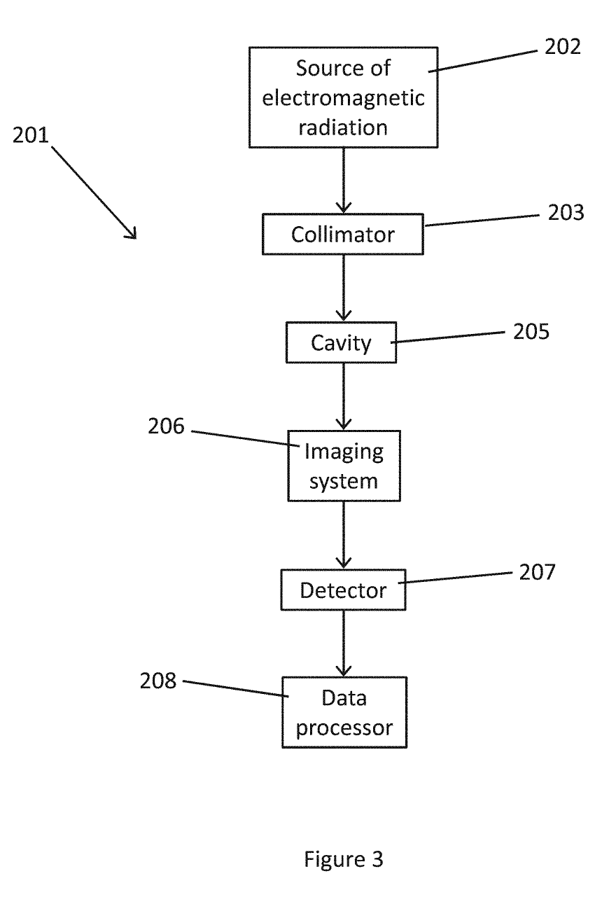

FIG. 3 shows a schematic overview of a spectrometer according to another embodiment of the present invention;

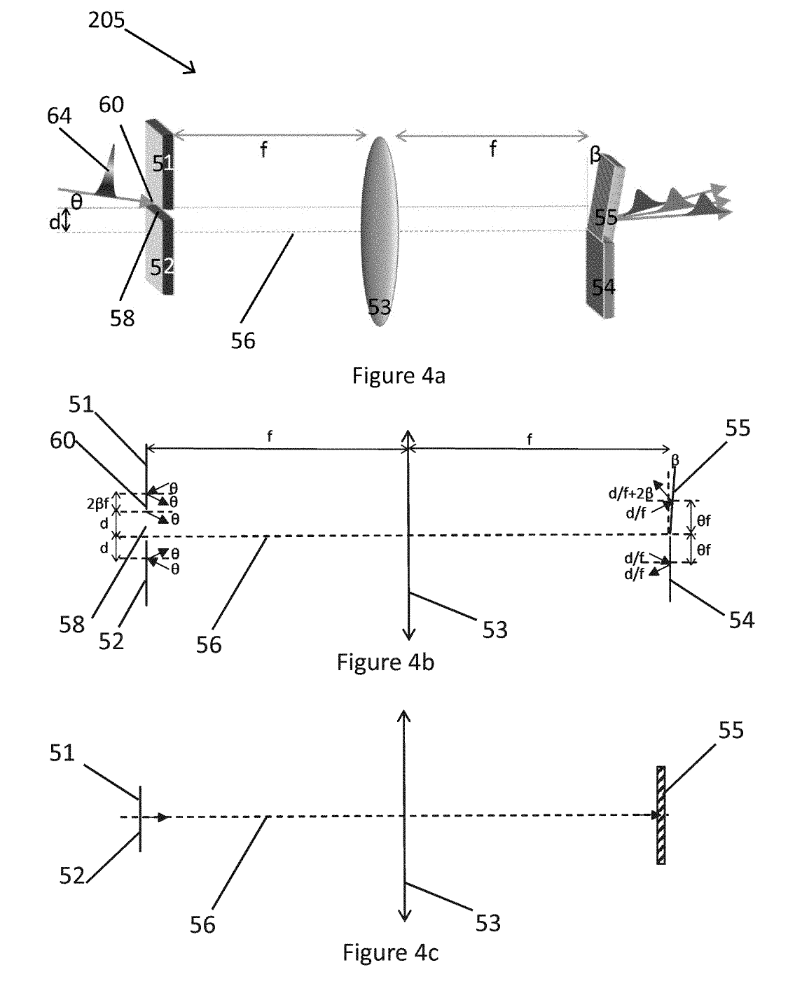

FIGS. 4a, 4b and 4c show the details of a cavity to be used in the spectrometer shown in FIG. 3;

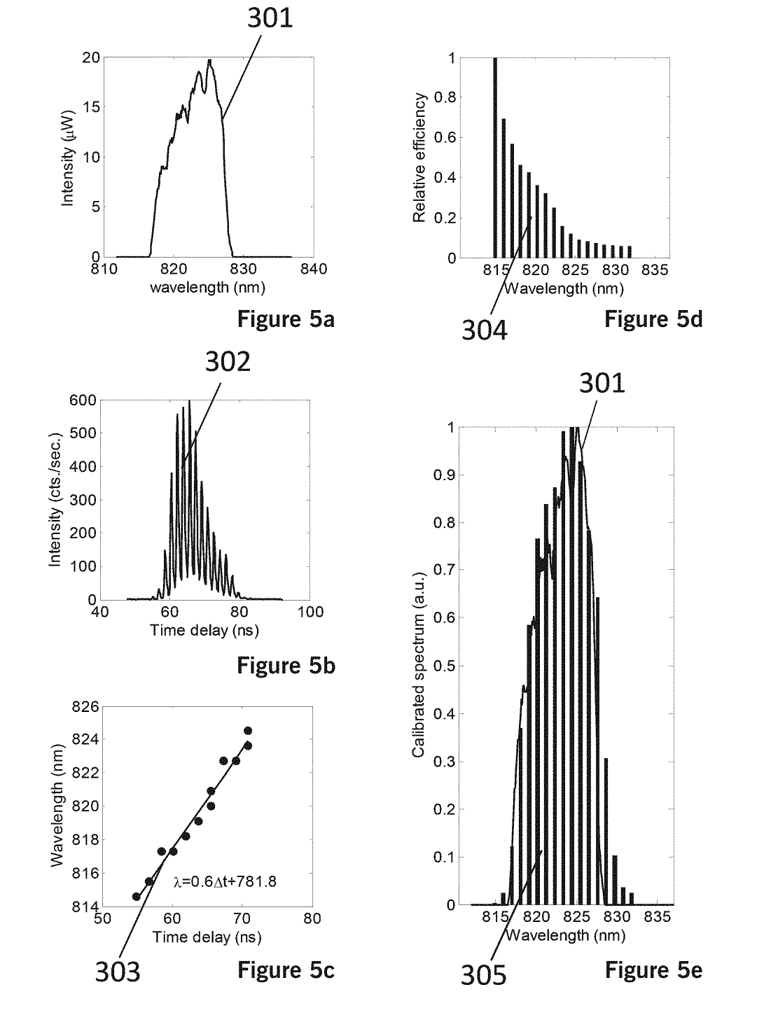

FIG. 5a shows an exemplary test spectrum for measurement by a spectrometer according to an embodiment of the present invention;

FIG. 5b shows the output of a detector of the spectrometer as captured by a data processor of the spectrometer;

FIG. 5c shows the calibration curve for the detector;

FIG. 5d shows the relative efficiency of the detector; and

FIG. 5e shows the determined spectrum compared to the test spectrum.

Preferred embodiments of a spectrometer in accordance with the present invention will now be described, which measures the spectrum of input electromagnetic radiation by converting the different wavelength components of the input electromagnetic radiation into different temporal components. Such a spectrometer has many different applications that each require the spectrum of, e.g. a pulse of, electromagnetic radiation to be measured. For example, lidar systems, remote detection of chemical traces and the characterisation of quantum light sources, may involve multiple, faint and/or pulsed light sources that are desired to be characterised.

FIG. 1 shows a schematic overview of a spectrometer 101 according to an embodiment of the present invention. In this embodiment the spectrometer 101 comprises a diffraction grating or prism 103 that is arranged to receive input electromagnetic radiation from a source of electromagnetic radiation 102 to be measured by the spectrometer 101. The spectrometer 101 also comprises an imaging system 104 that is arranged between the diffraction grating or prism 103 and the main cavity 105 of the spectrometer 101 that performs the temporal separation of the electromagnetic radiation input into the spectrometer 101, as will be described below.

The output of the cavity 105 is coupled to a detector 107, e.g. an avalanche photo diode, via an imaging system 106, with the detector 107 providing measurement data for analysis to a data processor 108.

A cavity 105 suitable for use with the spectrometer 101 shown in FIG. 1 will now be described with reference to FIGS. 2a, 2b and 2c which show the details of a cavity 105 to be used in the spectrometer 101 shown in FIG. 1. FIG. 2a shows a perspective view of the cavity 105; FIG. 2b shows a side view of the cavity 105;

and FIG. 2c shows a plan view of the cavity 105.

The cavity 105 comprises two sets of mirrors 1, 2, 4, 5 arranged at and defining each end of the cavity 105. Each set of mirrors 1, 2, 4, 5 have their reflective faces generally facing those of the other set, i.e. the two sets of mirrors 1, 2, 4, 5 are approximately parallel. A lens 3 is arranged in the optical path between the two sets of mirrors 1, 2, 4, 5, with the lens 3 defining an optical axis 6 of the cavity 105. The two sets of mirrors 1, 2, 4, 5 are arranged at a focal length f either side of the lens 3, with the two sets of mirrors 1, 2, 4, 5 oriented substantially in a plane perpendicular to the optical axis 6 of the cavity 105.

The first set of mirrors 1, 2 includes an upper portion 1 and a lower portion 2 that are separated by a distance that defines an aperture 8 for the input of electromagnetic radiation 10 (from the source of electromagnetic radiation 102) into the cavity. The aperture 8 forms a slit that is longitudinally extended in a direction perpendicular to the optical axis 6 of the cavity 105. The upper edge of the aperture 8, formed by a razor edge 10 at the lower edge of the upper portion 1 of the first set of mirrors 1, 2, is offset from the optical axis 6 by a distance in a direction perpendicular to the direction in which the aperture 8 is longitudinally extended (and thus the lower edge of the aperture 8 is defined by the upper edge of the lower portion 2 of the first set of mirrors 1, 2).

The upper portion 1 of the first set of mirrors 1, 2 lies in a plane perpendicular to the optical axis 6 of the cavity 105. The lower portion 2 of the first set of mirrors 1, 2 is rotated by an angle α to the upper portion 1 about an axis perpendicular to the optical axis 6 and to the direction in which the aperture 8 is longitudinally extended, such that the normal to the lower portion 2 is at an angle α to the optical axis 6, as can be seen from the plan view in FIG. 2c.

The second set of mirrors 4, 5 includes an upper portion 5 and a lower portion 4. The lower portion 4 of the second set of mirrors 4, 5 lies in a plane perpendicular to the optical axis 6 of the cavity 105. The upper portion 5 of the second set of mirrors 4, 5 is rotated by an angle β to the lower portion 4 about an axis that defines the boundary between the upper and lower portions 5, 4 of the second set of mirrors, such that the normal to the upper portion 5 is at an angle β to the optical axis 6, as can be seen from the side view in FIG. 2b. The optical axis 6 of the cavity 105 is perpendicular to and passes through the axis forming the boundary between the upper and lower portions 5, 4 of the second set of mirrors. The axis forming the boundary between the upper and lower portions 5, 4 of the second set of mirrors is also parallel to the direction in which the aperture 8 is longitudinally extended.

The upper portion 5 of the second set of mirrors 4, 5 has a razor edge 12 extending along one side of the upper portion 5 in a direction perpendicular to the axis forming the boundary between the upper and lower portions 5, 4 of the second set of mirrors.

Operation of this embodiment of the spectrometer will now be described with reference to FIGS. 1, 2a, 2b and 2c.

The source of electromagnetic radiation 102 to be measured is arranged to be incident upon the diffraction grating or prism 103 such that the electromagnetic radiation 102 is angularly separated (within a plane) into a plurality of different wavelength components 14.

The diffraction grating or prism 103 is arranged relative to the source of electromagnetic radiation 102 such that the resultant angularly separated wavelength components 14 of the electromagnetic radiation are incident upon an imaging system 104 which images (focusses) the electromagnetic radiation to be incident through the aperture 8 in the first set of mirrors 1, 2 and into the cavity 105 of the spectrometer 101, at a position that is offset by a distance d from the optical axis 6 of the cavity 105 in a direction perpendicular to the optical axis 6 and the direction in which the aperture 8 is longitudinally extended. The cavity 105 (and the aperture 8 in particular) is arranged such that the plane in which the angularly separated wavelength components 14 of the electromagnetic radiation that are imaged onto the aperture 8 of the cavity 105 is oriented at an angle θ to the optical axis 6 of the cavity 105. This plane containing the angularly separated wavelength components 14 passes (parallel) through the aperture 8 of the cavity with the wavelength components 14 passing close to the razor edge 10 of the upper portion 1 of the first set of mirrors 1, 2, offset by a distance d from the optical axis 6 of the cavity 105.

Owing to the wavelength components 14 of the input electromagnetic radiation being angularly separated and then imaged onto the aperture 8 of the cavity 105, it will be appreciated that the wavelength components 14 diverge as they enter the cavity 105 and travel towards the lens 3. When the different wavelength components 14 pass through the lens 3, owing to their angular separation and the first and second sets of mirrors 1, 2, 4, 5 each being arranged at a distance of a focal length f of the lens either side of the lens 3, the different wavelength components 14 are spatially Fourier transformed to different positions on the lower portion 4 of the second set of mirrors 4, 5. The different positions on the lower portion 4 onto which the different wavelength components 14 are spatially Fourier transformed are spaced from each other in a direction parallel to the axis forming the boundary between the upper and lower portions 5, 4 of the second set of mirrors but at the same distance from the optical axis 6 in a direction perpendicular to the axis forming the boundary between the upper and lower portions 5, 4 of the second set of mirrors.

As shown in FIG. 2b, the wavelength components 14 are incident upon the lower portion 4 of the second set of mirrors 4, 5. The position at which the wavelength components 14 are spatially Fourier transformed on the lower portion 4 of the second set of mirrors 4, 5 is offset by a distance θf from the optical axis 6 and the wavelength components 14 are incident upon the lower portion 4 of the second set of mirrors 4, 5 at an angle d/f to the normal of the lower portion 4 (in planes perpendicular to the axis forming the boundary between the upper and lower portions 5, 4 of the second set of mirrors).

Following reflection from the lower portion 4 of the second set of mirrors 4, 5, the different wavelength components 14 pass through the lens 3 and are spatially Fourier transformed to a position on the lower portion 2 of the first set of mirrors 1, 2. The position at which the wavelength components 14 are spatially Fourier transformed on the lower portion 2 of the first set of mirrors 1, 2 is offset by a distance d from the optical axis 6 and the wavelength components 14 are incident upon the lower portion 2 of the first set of mirrors 1, 2 at an angle θ to the normal of the lower portion 2 (in a plane perpendicular to the direction in which the aperture 8 is longitudinally extended).

Owing to the lower portion 2 of the first set of mirrors 1, 2 being at an angle α to the upper portion 1, the angle of each of the wavelength components 14, relative to the direction of the optical axis 6 and in a plane perpendicular to the planes of the upper and lower portions 1, 2 of the first set of mirrors, when reflected from the lower portion 2 of the first set of mirrors 1, 2, is rotated by 2α compared to the corresponding angle when the wavelength components 14 entered the cavity 105, as is shown in FIG. 2c.

Following reflection from the lower portion 2 of the first set of mirrors 1, 2, the different wavelength components 14 pass through the lens 3 and are spatially Fourier transformed to different positions on the upper portion 5 of the second set of mirrors 1, 2 (again, owing to the wavelength components 14 of the input electromagnetic radiation being angularly separated). The different positions on the upper portion 5 onto which the different wavelength components 14 are spatially Fourier transformed are spaced from each other in a direction parallel to the axis forming the boundary between the upper and lower portions 5, 4 of the second set of mirrors but at the same distance from the optical axis 6 in a direction perpendicular to the axis forming the boundary between the upper and lower portions 5, 4 of the second set of mirrors.

As shown in FIG. 2b, the wavelength components 14 are incident upon the upper portion 5 of the second set of mirrors 4, 5. The position at which the wavelength components 14 are spatially Fourier transformed on the upper portion 5 of the second set of mirrors 4, 5 is offset by a distance θf from the optical axis 6 and the wavelength components 14 are incident upon the upper portion 5 of the second set of mirrors 4, 5 at an angle d/f to the direction of the optical axis 6 (in planes perpendicular to the axis forming the boundary between the upper and lower portions 5, 4 of the second set of mirrors).

Owing to the upper portion 5 of the second set of mirrors 1, 2 being at an angle β to the lower portion 4, the angle of each of the wavelength components 14, relative to the direction of the optical axis 6 and in a plane perpendicular to the planes of the upper and lower portions 5, 4 of the second set of mirrors, when reflected from the upper portion 5 of the second set of mirrors 4, 5, is rotated by 2β, as is shown in FIG. 2c, compared to the angle that the wavelength components 14 would have been reflected from the upper portion 5 had it been coplanar with the lower portion 4.

Following reflection from the upper portion 5 of the second set of mirrors 4, 5, the different wavelength components 14 pass through the lens 3 and are spatially Fourier transformed to a position on the upper portion 2 of the first set of mirrors 1, 2. The position at which the wavelength components 14 are spatially Fourier transformed on the upper portion 1 of the first set of mirrors 1, 2 is offset by a distance d+2βf from the optical axis 6 and the wavelength components 14 are incident upon the upper portion 1 of the first set of mirrors 1, 2 at an angle θ to the normal of the upper portion 1 (in a plane perpendicular to the upper portion 1), as shown in FIG. 2b.

It will be appreciated that the wavelength components 14 now take a very similar path through the cavity 105, being reflected off the mirror portions 1, 2, 4, 5, compared to when the wavelength components 14 first entered the cavity 105 through the aperture 8, except that they start from a position further offset from the optical axis 6 (by a distance d+2βf compared to d when they entered the cavity 105, owing to the reflection from the angled upper portion 5 of the second set of mirrors 4, 5) and the angle of each of the wavelength components 14, relative to the direction of the optical axis 6 and in a plane perpendicular to the planes of the upper and lower portions 1, 2 of the first set of mirrors is rotated by 2α compared to the corresponding angle when the wavelength components 14 entered the cavity 105, owing to the angled lower portion 2 of the first set of mirrors 1, 2.

As the wavelength components 14 are directed at the same angle θ to the optical axis 6 as they were when they first entered the cavity 105, they will be incident upon the lower and upper portions 5, 4 of the second set of mirrors in the same positions in the plane perpendicular to the axis forming the boundary between the upper and lower portions 5, 4 of the second set of mirrors, e.g. as viewed from the side in FIG. 2b. However, owing to the rotation of the wavelength components 14 through the angle 2α in the plane perpendicular to the planes of the upper and lower portions 1, 2 of the first set of mirrors, the positions at which the wavelength components 14 are incident upon the upper and lower portions 5, 4 of the second set of mirrors are each shifted by a distance 2αf (in a direction parallel to the to the axis forming the boundary between the upper and lower portions 5, 4 of the second set of mirrors) compared to the position when the respective components 14 were previously incident on these upper and lower portions 5, 4 of the second set of mirrors, as shown in FIG. 2c.

As can be seen, for each round trip of the wavelength components 14 of the input electromagnetic radiation through the cavity 105 (i.e. involving a reflection from each of the mirror portions 1, 2, 4, 5), the position of incidence of each wavelength component 14 is shifted by a distance 2αf in a direction parallel to the to the axis forming the boundary between the upper and lower portions 5, 4 of the second set of mirrors and perpendicular to the razor edge 12 of the upper portion 5 of the second set of mirrors 4, 5. Thus each round trip moves the wavelength components 14 closer to the razor edge 12 until they exceed the position of the razor edge 12 and are thus output from the cavity 105.

The output wavelength components 14 are imaged by an imaging system 106, arranged beyond the razor edge 12 of the upper portion 5 of the second set of mirrors 4, 5, onto a detector 107 (e.g. an avalanche photo diode), which detects the arrival of each wavelength component 14.

Owing to the angular separation of the wavelength components 14 when they are input into the cavity 105 and thus the different wavelength components 14 being spatially Fourier transformed to different positions on the portions of the second set of mirrors 4, 5 (in a direction perpendicular to the razor edge 12 of the upper portion 5 of the second set of mirrors 4, 5) the different wavelength components 14 will exceed the position of the razor edge 12 after a different number of round trips through the cavity 105. This will therefore introduce a time delay between the different wavelength components 14. (The time delay is slightly over 8f/c, where f is the focal length of the lens and c is the speed of light.)

A signal, corresponding to the detection of arrival of each wavelength component 14 by the detector 107, is sent from the detector 107 to the data processor 108 for each detected wavelength component, with the data processor 108 being arranged to produce a time stamp for each arrival time of the wavelength components 14. These arrival times are then converted into wavelengths using a calibration of the spectrometer and their relative intensities determined using the relative efficiency of the spectrometer (as will be described later with reference to FIG. 5).

The Applicant also envisages a number of variants to the embodiment of the cavity shown in FIGS. 2a, 2b and 2c, which will now be described.

In one variant to the cavity shown in FIGS. 2a, 2b and 2c, the second set of mirrors 4, 5 is replaced with a single planar mirror that is arranged perpendicular to the optical axis, thus eliminating the angle β of the upper portion of the second set of mirrors in the previous embodiment. As the angle β was previously used to offset the reflected electromagnetic radiation the input aperture of the cavity, the aperture in this variant of the spectrometer is replaced with a reflective shutter, to prevent the reflected electromagnetic radiation from being incident upon the aperture and therefore escaping from the cavity. The shutter is configured to open to allow a pulse from the source of electromagnetic radiation into the cavity and to close such that the reflected electromagnetic radiation is reflected from the shutter upon incidence.

Operation of this variant of the cavity is the same as described above for the embodiment shown in FIGS. 2a, 2b and 2c, except that when the electromagnetic radiation is incident upon the (upper portion of the) second mirror, no angular shift of 2β is introduced, but instead the electromagnetic radiation is reflected back towards the shutter, where it is incident at the same position for each round trip.

In another variant of the cavity shown in FIGS. 2a, 2b and 2c, or to the variant described above, the razor edge 12 of the upper portion 5 of the second set of mirrors 4, 5 is replaced with an (upper) mirror portion that is arranged as a gradient spectral filter. This gradient spectral filter is arranged to transmit different wavelength components 14 of the electromagnetic radiation incident upon the (upper) mirror portion when the position of incidence of the different wavelength components 14 exceed different respective position thresholds on the mirror (in a direction parallel to the direction in which the input aperture is longitudinally extended) and otherwise reflect the wavelength components 14 of the electromagnetic radiation. Thus the (upper) mirror portion is arranged to transmit different wavelength components 14 at different positions, which introduces a time delay between the different wavelength components 14 of the input electromagnetic radiation.

Operation of this variant of the cavity is the same as described above for the embodiment shown in FIGS. 2a, 2b and 2c (and the variant above), except that the different wavelength components of the input electromagnetic radiation are output from the cavity when they are shifted to pass different particular positions on the (upper portion of the) second mirror such that the different wavelength components are transmitted through the mirror at different positions and thus at different times. Thus it will be appreciated that in this variant, like the embodiments described below, it is not necessary to angularly separate the electromagnetic radiation input into the cavity; it is possible to temporally separate the wavelength components by inputting the electromagnetic radiation in a, e.g. collimated, beam. Furthermore, the imaging device positioned after the exit from the cavity should be arranged to collect light from different positions, e.g. to focus all the wavelength components to a single point. A lens positioned at a distance one focal length from both the exit of the cavity and the detector would be suitable for this.

A further embodiment of the spectrometer according to the present invention will now be described, in which the input electromagnetic radiation is not angularly separated before being input into the cavity.

FIG. 3 shows a schematic overview of a spectrometer 201 according to this further embodiment of the present invention. The spectrometer of this embodiment is very similar to the embodiment shown in FIG. 1, but instead of a diffraction grating or prism, the spectrometer 201 comprises a collimator 203 that is arranged to receive input electromagnetic radiation from a source of electromagnetic radiation 202 to be measured by the spectrometer 201. The collimator is positioned between the source of electromagnetic radiation 202 and the main cavity 205 of the spectrometer 201 that performs the temporal separation of the electromagnetic radiation input into the spectrometer 201, as will be described below.

The same as for the embodiment shown in FIG. 1, the output of the cavity 205 is coupled to a detector 207, e.g. an avalanche photo diode, via an imaging system 206, with the detector 207 providing measurement data for analysis to a data processor 208.

A cavity 205 suitable for use with the spectrometer 201 shown in FIG. 3 will now be described with reference to FIGS. 4a, 4b and 4c which show the details of a cavity 405 to be used in the spectrometer 401 shown in FIG. 3. FIG. 4a shows a perspective view of the cavity 205; FIG. 4b shows a side view of the cavity 205; and FIG. 4c shows a plan view of the cavity 205.

Similar to the cavity shown in FIGS. 2a, 2b and 2c, the cavity 205 in this embodiment comprises two sets of mirrors 51, 52, 54, 55 arranged at and defining each end of the cavity 205. The arrangement of these mirrors is the same as in the previous embodiment, with a lens 53 positioned in the optical path between them and defining an optical axis 56 of the cavity, except that the lower portion 52 of the first set of mirrors 51, 52 is coplanar with the upper portion 51 of the first set of mirrors, i.e. not at an angle α as for the cavity of the previous embodiment.

A further difference to the cavity shown in FIGS. 2a, 2b and 2c is that, for the cavity 205 shown in FIGS. 4a, 4b and 4c, the upper portion 55 of the second set of mirrors 54, 55 does not comprise a razor edge but instead comprises an angle dependent spectral filter. This spectral filter is arranged to transmit different wavelength components of the electromagnetic radiation incident upon the upper portion 55 of the second set of mirrors 54, 55 when the angle of incidence of the different wavelength components exceed different respective angular thresholds on the upper portion 55 of the second set of mirrors 54, 55. Thus the upper portion 55 of the second set of mirrors 54, 55 is arranged to transmit different wavelength components at different positions, which introduces a time delay between the different wavelength components of the input electromagnetic radiation.

Operation of this embodiment of the spectrometer 205, which is similar to the previous embodiment, will now be described with reference to FIGS. 3, 4a, 4b and 4c.

The source of electromagnetic radiation 202 to be measured is arranged to be incident upon the collimator 203 such that the electromagnetic radiation 202 is collimated into a beam of electromagnetic radiation 64 (i.e. with all of the different wavelength components of the electromagnetic radiation 64 collinear in this beam).

The collimator 203 is arranged relative to the source of electromagnetic radiation 202 such that the resultant collimated beam of electromagnetic radiation 64 is incident through the aperture 58 in the first set of mirrors 51, 52 and into the cavity 205 of the spectrometer 201. The cavity 205 (and the aperture 58 in particular) is arranged such that the beam of electromagnetic radiation 64 is oriented at an angle to the optical axis 56 of the cavity 205 (in a plane perpendicular to the plane of the first set of mirrors 51, 52). The beam of electromagnetic radiation 64 is also arranged to pass through the aperture 58 of the cavity close to the razor edge 60 of the upper portion 51 of the first set of mirrors 51, 52, i.e. offset by a distance d from the optical axis 56 of the cavity 205.

Similar to the previous embodiment, the beam of input electromagnetic radiation 64 then passes through the lens 53 and is spatially Fourier transformed onto the lower portion 54 of the second set of mirrors 54, 55 at a position that is offset by a distance θf from the optical axis 56 of the cavity 205 and (as shown in FIG. 4b) at an angle d/f to the normal of the lower portion 54 (in a plane perpendicular to the axis forming the boundary between the upper and lower portions 55, 54 of the second set of mirrors).

Following reflection from the lower portion 54 of the second set of mirrors 54, 55, the beam of electromagnetic radiation 64 passes through the lens 53 and is spatially Fourier transformed to a position on the lower portion 52 of the first set of mirrors 51, 52. The position at which the beam of electromagnetic radiation 64 is spatially Fourier transformed on the lower portion 52 of the first set of mirrors 51, 52 is offset by a distance d from the optical axis 56 and the beam of electromagnetic radiation 64 is incident upon the lower portion 52 of the first set of mirrors 51, 52 at an angle θ to the normal of the lower portion 52 (in a plane perpendicular to the direction in which the aperture 58 is longitudinally extended).

In this embodiment the upper and lower portions 51, 52 of the first set of mirrors are coplanar and perpendicular to the optical axis 56, so no angular shift is introduced upon this reflection.

Following reflection from the lower portion 52 of the first set of mirrors 51, 52, the beam of electromagnetic radiation 64 passes through the lens 53 and is spatially Fourier transformed to a position on the upper portion 55 of the second set of mirrors 51, 52. The position on the upper portion 55 onto which the beam of electromagnetic radiation 64 is spatially Fourier transformed is offset by a distance θf from the optical axis 56 and the beam of electromagnetic radiation 64 is incident upon the upper portion 55 of the second set of mirrors 54, 55 at an angle d/f to the direction of the optical axis 56 (in a plane perpendicular to the axis forming the boundary between the upper and lower portions 55, 54 of the second set of mirrors), as shown in FIG. 4b.

Owing to the upper portion 55 of the second set of mirrors 51, 52 being at an angle to the lower portion 54, the angle the beam of electromagnetic radiation 64, relative to the direction of the optical axis 56 and in a plane perpendicular to the planes of the upper and lower portions 55, 54 of the second set of mirrors, when reflected from the upper portion 55 of the second set of mirrors 54, 55, is rotated by 2β, as is shown in FIG. 4c, compared to the angle that the beam of electromagnetic radiation 64 would have been reflected from the upper portion 55 had it been coplanar with the lower portion 54.

Following reflection from the upper portion 55 of the second set of mirrors 54, 55, the beam of electromagnetic radiation 64 passes through the lens 53 and is spatially Fourier transformed to a position on the upper portion 52 of the first set of mirrors 51, 52. The position at which the wavelength components 14 is spatially Fourier transformed on the upper portion 51 of the first set of mirrors 51, 52 is offset by a distance d+2βf from the optical axis 56 and the beam of electromagnetic radiation 64 is incident upon the upper portion 61 of the first set of mirrors 61, 62 at an angle θ to the normal of the upper portion 61 (in a plane perpendicular to the upper portion 61), as shown in FIG. 4b.

It will be appreciated that the beam of electromagnetic radiation 64 now takes a very similar path through the cavity 205, being reflected off the mirror portions 51, 52, 54, 55, compared to when the beam of electromagnetic radiation 64 first entered the cavity 205 through the aperture 58, except that it starts from a position further offset from the optical axis 56 (by a distance d+2βf compared to d when it entered the cavity 205, owing to the reflection from the angled upper portion 55 of the second set of mirrors 54, 55). As can be seen from FIG. 4c, in the plane parallel to the optical axis 56 and the aperture 58 the beam of electromagnetic radiation 64 is not shifted but simply is reflected back and forth along the optical axis 56, owing to the first set of mirrors 51, 52 being coplanar and perpendicular to the optical axis 56.

Thus, owing to the rotation of the beam of electromagnetic radiation 64 through the angle 2β by the angled upper portion 55 of the second set of mirrors 54, 55, the angle at which the beam of electromagnetic radiation 64 is incident upon the upper portion 55 of the second set of mirrors 54, 55 is shifted by an angle 2β for each round trip of the electromagnetic radiation 64 through the cavity 205, as shown in FIG. 2b.

The angle dependent spectral filter on the upper portion 55 of the second set of mirrors 54, 55 transmits electromagnetic wavelength when, for a particular wavelength component, the angle of incidence on the upper portion 55 of the second set of mirrors 54, 55 exceeds a threshold angle. Thus each round trip moves the angle of incidence of the beam of electromagnetic radiation 64 closer to the threshold angle for transmission for each wavelength component in the beam of electromagnetic radiation 64 (these threshold angles being different for each different wavelength component) until they exceed their angle of incident and are thus transmitted through the spectral filter of the upper portion 55 and output from the cavity 205.

The output wavelength components are imaged by a lens 206, arranged beyond the upper portion 55 of the second set of mirrors 54, 55, onto a detector 207 (e.g. an avalanche photo diode), which detects the arrival of each wavelength component 64.

Owing to the different threshold angles required for transmission through the spectral filter on the upper portion 55 of the second set of mirrors 54, 55 for the different wavelength components of the beam of electromagnetic radiation 64, the different wavelength components will exceed these respective threshold angles after a different number of round trips through the cavity 205. This will therefore introduce a time delay between the different wavelength components.

The signals from the detector 207, corresponding to the detection of each of the wavelength components in the beam of electromagnetic radiation 64 that are output from the cavity 205, are sent from the detector 207 to the data processor 208 to be processed in the same manner as the first embodiment described above, i.e. to be converted into wavelengths and relative efficiencies.

As with the first embodiment (shown in FIGS. 1, 2a, 2b and 2c), there are a number of variants to the embodiment of the cavity shown in FIGS. 4a, 4b and 4c that will now be described.

In one variant to the cavity shown in FIGS. 4a, 4b and 4c, the lower portion 52 of the first set of mirrors 51, 52 is oriented at an angle to the upper portion 51 about an axis perpendicular to the optical axis 56 and the aperture 58, i.e. the first set of mirrors 51, 52 is arranged as shown in FIGS. 2a, 2b and 2c. In addition, the angle dependent spectral filter on the upper portion 55 of the second set of mirrors 54, 55 is replaced with a position dependent (i.e. gradient) spectral filter. This spectral filter is arranged to transmit different wavelength components of the beam of electromagnetic radiation 64 incident upon the upper portion 55 of the second set of mirrors 54, 55 when the position of incidence of the different wavelength components exceed different respective position thresholds on the upper mirror portion 55 (in a direction parallel to the direction in which the input aperture 58 is longitudinally extended) and otherwise reflect the wavelength portions of the beam of electromagnetic radiation 64. Thus the upper portion 55 of the second set of mirrors 54, 55 is arranged to transmit different wavelength components at different positions, which introduces a time delay between the different wavelength components of the input beam of electromagnetic radiation 64.

Operation of this variant of the cavity is similar to that described above for the embodiment shown in FIGS. 4a, 4b and 4c, except that the different wavelength components of the input electromagnetic radiation are output from the cavity when they are shifted to exceed different particular positions on the upper portion 55 of the second set of mirrors 54, 55 such that the different wavelength components are transmitted through the mirror at different positions and thus at different times.

The operation of the data processor 108, 208 (as shown in FIGS. 1 and 3) for both embodiments and their variants described above will now be described with reference to FIG. 5, along with the calibration of the detector 107, 207 (as shown in FIGS. 1 and 3). FIG. 5a shows an exemplary test spectrum for measurement by the spectrometer, FIG. 5b shows the output of the detector as captured by the data processor, FIG. 5c shows the calibration curve for the detector, FIG. 5d shows the relative efficiency of the detector and FIG. 5e shows the determined spectrum compared to the test spectrum.

FIG. 5a shows an exemplary test spectrum 301, as measured by an optical spectrum analyser, for use in calibrating the spectrometer according to embodiments of the present invention. To calibrate the spectrometer the test spectrum 301 was input into the spectrometer, with the time delay outputs 302 of the different wavelength components, as captured by the detector and determined by the data processor, shown in FIG. 5b.

FIG. 5c shows the same test, as performed as described above in relation to FIGS. 5a and 5b, repeated for a number of test spectra of different wavelengths, in order to calibrate the time delays of the different wavelength components output from the cavity and measured by the detector to the actual wavelengths of these components (by determining a calibration curve 303) through the different points representative of the test spectra.

Using the same test spectra, the relative efficiency 304 of the spectrometer was determined, as is shown in FIG. 5d, for each of the wavelength components. This was done by comparing the intensity of the different wavelength components as measured by the detector (i.e. as shown in FIG. 5b) to the intensity of the corresponding wavelength components in the input electromagnetic radiation (i.e. as shown in FIG. 5a).

The result, using the calibration between the time delay and the wavelength, and the relative efficiency of the spectrometer, is shown in FIG. 5e, which shows the comparison between the determined wavelength of the wavelength components 305 (binned data) and the input test spectrum 301 (line data).

It can be seen from the above that in at least preferred embodiments of the invention, a spectrometer is provided that performs temporal separation of electromagnetic radiation input into the cavity using a free space spectrometer. This helps to allow a greater bandwidth spectrum of electromagnetic radiation to be analysed. The spectrometer enables spectra of electromagnetic radiation to be measured efficiently owing to the temporal separation of the different wavelength components of the spectra into multiple different time bins. Thus it may not be necessary to use a detector that is able to measure a range of frequencies at different spatial positions, but instead, a single channel detector may be able to be used that has a fast repetition rate and high sensitivity. This then enables electromagnetic radiation from correlated or dynamic systems to be measured more efficiently by the spectrometer according to embodiments of the present invention. Furthermore, the spectrometer of the present invention may be tuned easily, e.g. by the angle(s) of the mirror(s) that are chosen.

The work leading to this invention has received funding from the People Programme (Marie Curie Actions) of the European Union's Seventh Framework Programme (FP7/2007-2013) under REA grant agreement n°627372 and n°300820. The work leading to this invention has received funding from the European Union Seventh Framework Programme (FP7/2007-2013) under grant agreement n°600645.

1. A spectrometer for temporally separating input electromagnetic radiation, the spectrometer comprising:
a cavity comprising a first mirror and a second mirror arranged to reflect input electromagnetic radiation therebetween, wherein the first mirror comprises an aperture arranged to allow electromagnetic radiation to be input into the cavity through the aperture; and
an imaging device arranged in the path taken by the electromagnetic radiation between the first and second mirrors, wherein the imaging device defines an optical axis of the cavity and the imaging device is arranged to perform a spatial Fourier transform of the input electromagnetic radiation from the aperture in the first mirror onto the second mirror and to perform a spatial Fourier transform of the reflection of the electromagnetic radiation from the second mirror back onto the first mirror;
wherein at least a portion of one or both of the first and second mirrors has a normal that is arranged at a non-parallel angle to the optical axis of the cavity, such that the position and/or angle of incidence on the second mirror of electromagnetic radiation input into the cavity through the aperture in the first mirror is shifted after each round trip of the electromagnetic radiation through the cavity; and
wherein the second mirror is arranged to allow a wavelength component of the electromagnetic radiation to be output from the cavity when the position and/or angle of incidence of the electromagnetic radiation on the second mirror after one or more round trips of the cavity exceeds a particular threshold such that different wavelength components of the input electromagnetic radiation are output from the cavity after completing a different number of round trips of the cavity.

2. A spectrometer as claimed in claim 1, wherein the spectrometer is configured to measure the wavelength components of electromagnetic radiation having wavelengths between 200 nm and 2 μm.

3. (canceled)

4. A spectrometer as claimed in claim 1, 2 or 3, wherein the spectrometer comprises an angular separation device arranged to angularly separate electromagnetic radiation that is incident upon it and to direct the angularly separated electromagnetic radiation through the aperture and into the cavity, and wherein the angular separation device is arranged to angularly separate the incident electromagnetic radiation dependent upon the wavelength components of the electromagnetic radiation.

5. (canceled)

6. A spectrometer as claimed in claim 4, wherein the spectrometer comprises an input imaging device arranged to focus the angularly separated electromagnetic radiation from the angular separation device onto the aperture of the cavity such that the electromagnetic radiation angularly diverges in the cavity.

7. A spectrometer as claimed in claim 1, wherein the electromagnetic radiation is arranged to be directed into the cavity at a non-parallel angle to the optical axis of the cavity.

8. A spectrometer as claimed in claim 1, wherein the first mirror comprises two separate portions defining the aperture therebetween, and wherein one of the portions of the first mirror has a normal that is arranged at a non-parallel angle to the optical axis of the cavity.

9. A spectrometer as claimed in claim 1, wherein the aperture is longitudinally extended in a direction perpendicular to the optical axis of the cavity and/or the aperture is offset by a distance from the optical axis of the cavity in a direction perpendicular to the optical axis.

10. (canceled)

11. (canceled)

12. A spectrometer as claimed in claim 8, wherein the aperture is longitudinally extended in a direction perpendicular to the optical axis of the cavity, and wherein the two portions of the first mirror are rotated with respect to each other about an axis that extends in a direction perpendicularly to the aperture in the first mirror and perpendicularly to the optical axis of the cavity.

13. (canceled)

14. A spectrometer as claimed in claim 1, wherein the aperture is longitudinally extended in a direction perpendicular to the optical axis of the cavity, wherein the second mirror comprises two portions, wherein one of the portions of the second mirror has a normal that is arranged at a non-parallel angle to the optical axis of the cavity, and wherein the two portions of the second mirror are rotated with respect to each other about an axis that extends in a direction perpendicularly to the optical axis of the cavity and parallel to the direction in which the aperture in the first mirror is longitudinally extended.

15. A spectrometer as claimed claim 1, wherein the cavity is arranged such that the round trip of the electromagnetic radiation through the cavity involves the electromagnetic radiation passing via the imaging device four times to return to substantially the same position on the second mirror.

16. A spectrometer as claimed in claim 1, wherein the second mirror is arranged to allow a wavelength component of the electromagnetic radiation to be output from the cavity when the position of incidence of the electromagnetic radiation on the second mirror after one or more round trips of the cavity exceeds a particular position threshold.

17. A spectrometer as claimed in claim 16, wherein the second mirror comprises a razor edge that defines the position threshold or a gradient spectral filter comprising a plurality of spectral edges that is arranged to transmit a plurality of wavelength components of the electromagnetic radiation when the wavelength components exceed respective position thresholds on the second mirror.

18. A spectrometer as claimed in claim 17, wherein the razor or spectral edge forms a straight line that extends in a direction that is perpendicular to the direction in which the electromagnetic radiation is shifted after each round trip through the cavity.

19. A spectrometer as claimed in claim 1, wherein the second mirror is arranged to allow a wavelength component of the electromagnetic radiation to be output from the cavity when the angle of incidence of the electromagnetic radiation on the second mirror after one or more round trips exceeds a particular angular threshold.

20. A spectrometer as claimed in claim 19, wherein the second mirror comprises an angle-dependent spectral filter arranged to transmit a plurality of wavelength components of the electromagnetic radiation when the wavelength components exceed respective angular thresholds on the second mirror.

21. A spectrometer as claimed in claim 1, wherein the second mirror is arranged to allow a wavelength component of the electromagnetic radiation to be output from the cavity when the position and angle of incidence of the electromagnetic radiation on the second mirror after one or more round trips of the cavity exceed particular position and angular thresholds.

22. A spectrometer as claimed in claim 21, wherein the second mirror comprises a gradient dielectric filter arranged to transmit a plurality of wavelength components of the electromagnetic radiation when the wavelength components exceed respective angular and position thresholds on the second mirror.

23. A spectrometer as claimed in claim 1, wherein the spectrometer comprises a detector arranged relative to the cavity such that the wavelength components output from the cavity are incident upon the detector.

24. (canceled)

25. A spectrometer as claimed in claim 23, wherein the detector is connected to a processing system arranged to receive signals from the detector, and to determine from the signals the time delays between the arrival of the wavelength components at the detector.

26. A spectrometer as claimed in claim 25, wherein the processing system is arranged to use the determined time delays to determine the wavelengths of the wavelength components output from the cavity.
